(19) United States
(12) Patent Application Publication
(10) Pub. No.: US 2006/0279218 A1
(43) Pub. Date: Dec. 14, 2006

(54) High-pressure discharge lamp, high-pressure discharge lamp operating apparatus, and illuminating apparatus

(75) Inventors: Kozo Uemura, Kanagawa-ken (JP); Masazumi Ishida, Kanagawa-ken (JP); Hiroshi Kamata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA LIGHTING & TECHNOLOGY CORPORATION

(21) Appl. No.: 11/451,432

(22) Filed: Jun. 13, 2006

(30) Foreign Application Priority Data
Jun. 14, 2005 (JP) 2005-174167
Sep. 22, 2005 (JP) 2005-276884

(51) Int. Cl. H01J 61/30; H01J 17/16

(52) U.S. Cl. 313/636

(57) ABSTRACT

The present invention provides a high-pressure discharge lamp in which a seal part between the translucent ceramics discharge vessel and the current introducing conductor has an improved sealing capability, as well as a high-pressure discharge lamp operating apparatus and an illuminating apparatus which use the high-pressure discharge lamp. A high-pressure discharge lamp MHL includes a translucent ceramics discharge vessel 1 having an opening 1b, a current introducing conductor 2 inserted into and sealed to the opening, electrodes 3 connected to the current introducing conductor 2 and sealed in the translucent ceramics discharge vessel, and a discharge medium. The sealing of the current introducing conductor is provided by the fusion of ceramics in the opening of the translucent ceramics discharge vessel or/and a material of the same quality as that of a material of a part of the current introducing conductor which is opposite the opening.

### BACKGROUND OF THE INVENTION

1. Field of the Invention

The present invention relates to a high-pressure discharge lamp comprising a translucent ceramics discharge vessel, and a high-pressure discharge lamp operating apparatus and an illuminating apparatus both using the high-pressure discharge lamp.

2. Description of the Related Art

For high-pressure discharge lamps comprising conventional translucent ceramics discharge vessels, various means have been proposed and experimentally used to seal the discharge container via a current introducing conductor. The most popular means uses glass frits (see, for example, Japanese Patent Laid-Open No. 06-196131).

However, if glass frits are used to seal the translucent ceramics discharge vessel as described in Japanese Patent Laid-Open No. 06-196131, the insufficient heat resistance of the glass frits results in the need to suppress an increase in the temperature of a seal part as required in order to obtain an appropriate lamp lifetime characteristic. This in turn requires the following configuration to be adopted.

(1) What is called a capillary structure is formed by extending a small-diameter cylindrical part along the tube axis from the opposite ends of a surrounding part defining a discharge space.

(2) A possible load on a tube wall is reduced.

This configuration presents the following problems.

The arrangement (1) increases the entire length of the lamp, which further poses the following problems.

The capillary part is likely to be broken.

Several times, in some cases, 10 or more times as large an amount of discharge medium such as halide needs to be sealed as that required if no capillary is formed. This disadvantageously leads to a cost increase, the reduced stability of the discharge medium, degraded starting capability, turbidity or blackening, and worn electrodes; the degraded starting capability results from an increase in the amount of impurity gas emitted by the discharge medium.

The arrangement (2) reduces the temperature to prevent the halide from sufficiently evaporating. This precludes vapor pressure from being increased. As a result, light emission efficiency cannot be increased to an intended level. Further, a halide cannot be used which offers appropriate light emission characteristics but which has a high reactivity.

### SUMMARY OF THE INVENTION

An object of the present invention is to provide a high-pressure discharge lamp having a translucent ceramics discharge vessel with an improved sealing structure to eliminate disadvantages associated with sealing with glass frits in the conventional technique, as well as a high-pressure discharge lamp operating apparatus and an illuminating apparatus.

Another object of the present invention is to provide a high-pressure discharge lamp in which the sealing between the translucent ceramics discharge vessel and a current introducing conductor is achieved mostly by fusing at least either the ceramics in the translucent ceramics discharge vessel or the current introducing conductor, instead of using frit glass for a seal part between the translucent ceramics discharge vessel and the current introducing conductor, as well as a high-pressure discharge lamp operating apparatus and an illuminating apparatus both using the high-pressure discharge lamp.

The present invention can provide a high-pressure discharge lamp that makes it possible to improve the sealing performance of the seal part between the translucent ceramics discharge vessel and the current introducing conductor without using any frit glass, as well as a high-pressure discharge lamp operating apparatus and an illuminating apparatus using the high-pressure discharge lamp.

According to the present invention, the omission of frit glass enables the temperature of coolest part of the translucent ceramics discharge vessel to be set at a larger value. This enables a further increase in the vapor pressure of a halide to improve luminous efficiency.

Further, according to the present invention, the omission of frit glass results in that a small-diameter cylindrical part that forms a small gap called a capillary inside the lamp is not necessarily needed, thus further exerting the following effects in this case.

(1) The shock resistance and thermal shock resistance of the translucent ceramics discharge vessel are further improved.

(2) The omission of the small-diameter cylindrical part enables a reduction in the axial size of translucent ceramics discharge vessel and thus the size of the high-pressure discharge lamp.

(3) Discharge medium entering the capillary becomes unnecessary, thus enabling the amount of discharge medium sealed to be reduced. The amount of impurities mixed in the discharge medium thus decreases to improve starting capability. This results in reduced turbidity and blackening, improved light flux maintenance rate, and reduced wear of electrodes. As a result, the lifetime characteristic of the high-pressure discharge lamp is improved. Further, a decrease in the amount of discharge medium sealed enables a reduction in the cost of the high-pressure discharge lamp.

The high-pressure discharge lamp of the present invention comprises a translucent ceramics discharge vessel including an opening; a current introducing conductor inserted and sealed in the opening of the translucent ceramics discharge vessel; electrodes connected to the current introducing conductor and sealed in the translucent ceramics discharge vessel; and a discharge medium sealed in the translucent ceramics discharge vessel. The sealing of the current introducing conductor comprises fusion of at least one of the ceramics in the opening of the translucent ceramics discharge vessel or/and a material of the same quality as that of a material of a part of the current introducing conductor which is opposite the opening.

In the present invention, the definitions and technical meanings of terms are as follows.

[Translucent ceramics discharge vessel] The translucent ceramics discharge vessel consists of a ceramic material offering translucency and heat resistance, such as single-crystal metal oxide, for example, sapphire, polycrystalline metal oxide, for example, semitransparent airtight aluminum oxide, yttrium-aluminum-garnet (YAG), or yttrium oxide (YOX), and polycrystalline non-oxide, for example, aluminum nitride (AlN). A discharge space that is airtight to the exterior is formed inside the translucent ceramics discharge vessel. Of the above materials, translucent polycrystalline alumina ceramics are preferable as a component of the translucent ceramics discharge vessel because of their possibility of industrial mass production and their availability.

Common translucent polycrystalline alumina ceramics have an average crystal grain size of several 10 s of μm. However, according to the present invention, at least the opening preferably has an average crystal grain size of at most 4 μm. In other words, if the opening at least has an average crystal grain size of at most 4 μm, when the ceramics in the opening are melted for sealing, the ceramics stick well to the introducing conductor. Further, during cooling following the junction between the opening and the introducing conductor as a result of the melting, cracks are unlikely to occur in the joint or its vicinity. An average crystal grain size of at most 1 μm causes few cracks even with the junction and is thus further preferable. This exerts a particularly excellent effect in the present invention. An average crystal grain size of at most 0.5 μm causes no cracks even with the junction and is optimum.

If at least the opening of the translucent ceramics discharge vessel has an average crystal grain size of at most 4 μm, the area having an average crystal grain size of at most 4 μm may be only the opening or the entire translucent ceramics discharge vessel. An area of the translucent ceramics discharge vessel which is different from the opening may have an average crystal grain size of at most 4 μm as required.

The translucency of the translucent ceramics discharge vessel is at such a level that the translucent ceramics discharge vessel can allow light generated by discharge to pass through to the exterior. The translucent ceramics discharge vessel may be transparent or may diffuse light. At least a main part of a part of the translucent ceramics discharge vessel which surrounds the discharge space has only to achieve translucency. In other words, when a supplementary structure different from the main part is provided, this part may block light.

The translucent ceramics discharge vessel comprises the surrounding part to surround the discharge space. The interior of the surrounding part, that is, the discharge space, may have an appropriate shape such as a sphere, an elliptical sphere, or an almost cylindrical shape. Any of various values may be selected for the volume of the discharge space depending on the rated lamp power of the high-pressure discharge lamp, the distance between the electrodes, or the like. For example, the volume may be at most 0.5 cc for a liquid crystal projector lamp. The volume may be at most 0.05 cc for an automotive headlamp. For a common illumination lamp, the volume may be at least or at most 1 cc depending on the rated lamp power.

The translucent ceramics discharge vessel also comprises the opening that is in communication with the surrounding part. At least the current introducing conductor, described later, is inserted and sealed in the opening, which thus functions to seal the translucent ceramics discharge vessel. The opening also enables the discharge medium, described later, to be sealed in the translucent ceramics discharge vessel, that is, the surrounding part.

The number of openings is two so as to seal a common pair of electrodes but may be one or three or more depending on the number of current introducing conductors disposed. If two openings are disposed in order to seal a pair of electrodes, the openings are disposed at separate positions but are preferably located separately from and opposite each other along the tube axis.

A cylindrical intermediate member may be additionally used which is separate from the opening when the translucent ceramics discharge vessel is formed but which is integrated with the opening after it has been sealed in the opening together with the current introducing conductor. In other words, the seal is formed not only by the direct fusion between the current introducing conductor and the opening formed integrally with the translucent ceramics discharge vessel but only by the interposition of a cylindrical ceramic intermediate material between the current introducing conductor and the opening integrated with the translucent ceramics discharge vessel. The intermediate member may be a cylindrical solid, powder, or the like. The intermediate member is fused to the opening and current introducing conductor to form a proper seal between them. Provided that the intermediate member has an average crystal grain size of at most 4 μm, the current introducing conductor sticks well to the opening even if the opening, integrated with the translucent ceramics discharge vessel, does not have an average crystal grain size of at most 4 μm. In this case, the opening may of course have an average crystal grain size of at most 4 μm.

The opening may be formed contiguous to the surrounding part or a small-diameter cylindrical part contiguous to the surrounding part may be additionally formed with the opening formed at an end of the small-diameter cylindrical part which is opposite the surrounding part. In the latter case, the small-diameter cylindrical part may have an arbitrary length. The ceramics in the opening may block light.

The small-diameter cylindrical part is used to form what is called a capillary structure conventionally employed to seal the translucent ceramics discharge vessel using frit glass. The present invention also allows the small-diameter cylindrical part to be provided so as to form a capillary structure as required. However, even if the capillary structure is not formed, the opening can be reliably sealed by forming a short cylindrical part at the opening. With any of the above arrangements, the opening is formed to have a size and shape such that when the current introducing conductor is inserted into the opening and the translucent ceramics in the opening are melted, the melted translucent ceramics can be welded to the current introducing conductor. The seal part may have a length of about 1 to 7 mm, preferably 1.5 to 4 mm, along the tube axis.

Means for melting the ceramics in the opening to seal the translucent ceramics discharge vessel is not particularly limited. For example, by heating the ceramics in the opening at least to their melting point, it is possible to melt the ceramics to allow them to stick to the surface of the current introducing conductor inserted into the opening. Then, the heating is stopped to cool the sticking part. This solidifies the ceramics to seal the current introducing conductor in the opening, which is thus sealed. Means for heating the ceramics in the opening is not particularly limited. It is possible to use, for example, heat projecting local heating means such as a laser or a halogen lamp with a reflector, inductive heating means, or an electric heater. The laser may be, for example, a YAG laser or a CO₂ laser.

If the heat projecting local heating means is used to heat the entire circumference of the opening, the entire circumference of the opening can be uniformly heated by fixing the local heating means at a predetermined position separate from the opening, for example, on either side of the opening, and rotating one or both of the opening of the translucent ceramics discharge vessel and the local heating means while operating the local heating means. However, the translucent ceramics discharge vessel may be kept stationary during heating as required by emitting laser light in the direction in which the opening extends, for example, along the tube axis, arranging a plurality of local heating means around the fixed opening, rotating the local heating means around the opening, or disposing heating means so that it surrounds the entire circumference of the opening.

To produce a translucent ceramics discharge vessel, it is possible to integrally mold the surrounding part or to join or fit a plurality of components to one another. For example, if an additional structure such as a small-diameter cylindrical part is provided besides the surrounding part, it may be integrally molded from the beginning at one or both ends of the surrounding part. However, the integral translucent ceramics discharge vessel can be formed by, for example, temporally sintering the surrounding part and the additional structure separately, joining them together as required, and then sintering the whole structure. Alternatively, the integral surrounding part may be formed by temporarily sintering the cylindrical part and an end plate part separately, joining them together as required, and then sintering the whole structure.

[Current introducing conductor] The current introducing conductor applies a voltage to the electrodes described later to supply them with a current and functions to seal the translucent ceramics discharge vessel. To achieve this, the current introducing conductor has a leading end inserted into the opening of the translucent ceramics discharge vessel and connected to the electrodes, and a base end exposed from the translucent ceramics discharge vessel. To be exposed from the translucent ceramics discharge vessel, the base end may project from the translucent ceramics discharge vessel or may face the exterior without projecting so that the current introducing conductor can be supplied with power by an external source.

The current introducing conductor may be a sealing metal, that is, a conductive metal having a coefficient of thermal expansion similar to that of the translucent ceramics constituting the translucent ceramics discharge vessel, for example, niobium (Nb), tantalum (Ta), titanium (Ti), zirconium (Zr), hafnium (Hf), vanadium (V), platinum (Pt), molybdenum (Mo), or tungsten (W), or cermet. If aluminum oxide such as alumina ceramics is used as a material for the translucent ceramics discharge vessel, niobium, tantalum, and molybdenum can preferably be used for sealing because the average coefficients of thermal expansion of niobium and tantalum are similar to that of the aluminum oxide and because the average coefficient of thermal expansion of molybdenum is close to that of the aluminum oxide. There is also only a small difference in the average coefficient of thermal expansion between these metals and yttrium oxide or YAG. If aluminum nitride is used for the translucent ceramics discharge vessel, zirconium is desirably used for the current introducing conductor. Alternatively, the current introducing conductor may be formed by joining a plurality of material parts. For example, the current introducing conductor may partly be formed of a metal selected from the above group, and cermet may be joined to this metal part along the tube axis or in a circumferential direction orthogonal to the tube axis. If the current introducing conductor is at least partly formed of cermet, the cermet part of the current introducing conductor can be sealed to the opening of the translucent ceramics discharge vessel.

The ceramics constituting the cermet may be alumina ceramics. The metal constituting the cermet may consist of one or more metals selected from the above group, for example, molybdenum and tungsten. The cermet part of the current introducing conductor which is sealed to the translucent ceramics discharge vessel may include at least a metal component such as niobium (Nb), molybdenum (Mo), or tungsten and a ceramic component such as alumina, YAG, or yttrium. The content of the metal component may be 5 to 60 mass %.

If the cermet is composed of the above components, when the part to be sealed by the heating means is heated, heat absorption is, though depending on the manner of heating, generally unlikely to occur in the translucent ceramics discharge vessel. In contrast, the cermet surface absorbs a large quantity of heat and is thus heated; its temperature rises. The heat is further transferred to the opening of the translucent ceramics discharge vessel to melt the sealing target part.

Since the content of the metal component is at most 60 mass %, there is only a small difference in the coefficient of thermal expansion between the current introducing conductor and the translucent ceramics discharge vessel. This suppresses damage and leakage caused by heat shock when the high-pressure discharge lamp is lighted, compared to the configuration in which the translucent ceramics discharge vessel comes into direct contact with molybdenum.

The current introducing conductor may be formed of the sealing metal such as niobium which is shaped like a bar, a pipe, or a coil. A coil may be wound around the bar-like current introducing conductor. The pipe- or coil-like current introducing conductor must be closable so as to prevent sealing of interior of the translucent ceramics discharge vessel from being hindered. Further, since niobium or the like is readily oxidized, if the high-pressure discharge lamp is in communication with the air during lighting, the current introducing conductor needs to be prevented from contacting the air. This can be achieved by further connecting an oxidation-resistant conductor to the current introducing conductor and covering the part of the translucent ceramics discharge vessel exposed through the opening, with an airtight substance such as frit glass.

The current introducing conductor is functionally divided into a part mostly sealed to the opening of the translucent ceramics discharge vessel and a part that mostly supports the electrodes. Thus, to optimize the respective functions, these parts may be formed of different materials or formed so as to have different sizes or structures so as to be connected together to construct the current introducing conductor. For example, it is known that niobium is used to form the part mostly sealed to the opening of the translucent ceramics discharge vessel and that a halogen-resistant metal is used to form the part that mostly supports the electrodes. In the present invention, these parts may conform to different specifications, that is, may be composed of different materials or may have different sizes or shapes depending on a main function. They may be connected together along the tube axis to construct the current introducing conductor. However, the present invention allows the current introducing conductor to be composed of a conductive member of the same material over almost the entire length as required. In this case, to provide the respective functions, other materials may be added to the periphery of the conductive member as required. For example, the part welded to the opening in the current introducing conductor need not necessarily be conductive. Accordingly, a material containing a large amount of ceramic component may be provided around the periphery of the conductive material and welded to a part of the conductive member.

Now, description will be given of the means for providing the seal between the opening of the translucent ceramics discharge vessel and the current introducing conductor. The present invention includes aspects described below. In each aspect, the seal is formed by fusing a material of the same quality as that of the opening of the translucent ceramics discharge vessel or/and the seal part of the current introducing conductor. None of the aspects involves the interposition of a material component such as SiO₂ or Dy₂O₃ which is different from the conventional material of the translucent ceramics discharge vessel and the seal part of the current introducing conductor, for example, frit glass.

(1) Aspect in which the fusion occurring is mostly that of the ceramics in the opening of the translucent ceramics discharge vessel to the current introducing conductor.

(2) Aspect in which fusion mostly occurs in the part of the current introducing conductor which is opposite the opening of the translucent ceramics discharge vessel.

(3) Aspect in which the ceramics in the opening of the translucent ceramics discharge vessel and the current introducing conductor are fused together.

(4) Aspect in which fusion mostly occurs in the ceramics in the opening of the translucent ceramics discharge vessel and a sealing material of the same quality as that of the part of the current introducing conductor which is opposite the opening of the translucent ceramics discharge vessel. The sealing material may be pre-integrated with the current introducing conductor or prepared separately from the current introducing conductor.

[Electrodes] The electrodes are means for inducing discharge of the discharge medium described later, inside the translucent ceramics discharge vessel. In general, the paired electrodes are disposed separately from and opposite each other so as to induce arc discharge between the electrodes inside the translucent ceramics discharge vessel. In the present invention, at least one electrode is connected to the introducing conductor and sealed in the translucent ceramics discharge vessel.

The electrodes are connected to the current introducing conductor and supported at a predetermined position in the translucent ceramics discharge vessel. For example, the base end of each electrode is connected to the leading end of the current introducing conductor which is located inside the translucent ceramics discharge vessel.

The electrode may be composed of an electrode main part or/and an electrode shaft part. The electrode main part constitutes a start point for discharge and thus mainly operates as a cathode and/or an anode. The electrode main part may be connected directly to the current introducing conductor rather than via the electrode shaft part as required. Further, in order to increase the surface area of the electrode main part to provide appropriate radiation, a tungsten coil may be wound around the electrode main part or the electrode main part may have a larger diameter than the electrode shaft part as required. If the electrode comprises the electrode shaft part, the electrode shaft part is integrated with or welded to the electrode main part so as to project rearward from its rear surface of the electrode main part to support it. The electrode shaft part is also connected to the current introducing conductor. The electrode shaft part and the leading end of the current introducing conductor may be integrated together via a single piece of tungsten as required.

Examples of electrode materials include tungsten, doped tungsten, thoriated tungsten, rhenium, and a tungsten-rhenium alloy.

If a pair of electrodes is used, they have a symmetric structure for AC lighting but may have an asymmetric structure for DC lighting.

[Discharge Medium] The discharge medium is means for achieving desired light emission through its own discharge. In the present invention, the configuration of the discharge medium is not particularly limited. For example, aspects listed below may be used. However, the discharge medium may preferably be composed of a halide of a luminous metal, a lamp voltage forming medium, and a rare gas. In the present invention, the “high-pressure discharge” refers to discharge that sets the pressure of an ionizing medium equal to or higher than the atmospheric pressure during lighting; this concept embraces what is called super-high-pressure discharge.

The halide of a luminous metal mainly emits visible light and may be any of various known metal halides. That is to say, the metal halide of a luminous metal may be arbitrarily selected from a group of known metal halides as desired so as to achieve radiation of visible light with desired emission characteristics such as a general color rendering index Ra and luminous efficiency or depending on the size or input power of the translucent ceramics discharge vessel. For example, one or more halides may be selected from a group of sodium (Na), scandium (Sc), rare earth metal (dysprosium (Dy), thulium (Tm), holmium (Ho), praseodymium (Pr), lantern (La), or cerium (Ce), or the like), thallium (Tl), indium (In), and lithium (Li).

The lamp voltage forming medium is effective in forming a lamp voltage and may be, for example, mercury or a halide of any of the metals listed below. The halide as a lamp voltage forming medium is preferably a halide of a metal such as aluminum (Al), iron (Fe), zinc (Zn), antimony (Sb), or manganese (Mn) which serves to generate a relatively high vapor pressure during lighting and which emits a smaller quantity of light in a visible region than the above luminous metal.

The rare gas acts as a starting gas or a buffer gas and may be xenon (Xe), argon (Ar), krypton (Kr), or neon (Ne) singly or a mixture of any of them.

1. A halide of a luminous metal+mercury+rare gas: what is called a mercury-containing metal halide lamp configuration

2. A halide of a luminous metal+halide as a lamp voltage forming medium+rare gas: what is called a mercury-free metal halide lamp configuration that does not use mercury, which imposes a heavy load on the environment.

3. Mercury+rare gas: what is called a high-pressure mercury lamp configuration

4. Rare gas: what is called a xenon lamp configuration if the rare gas is Xe

For the halide of a luminous metal, one or more of iodine, bromide, chlorine, and fluorine may be used as halogen.

[Effects of the Present Invention] In the present invention, heating means such as a laser may be used to intensively heat the member to be melted in order to fuse the ceramics in the opening of the translucent ceramics discharge vessel or/and a material of the same quality as that of the material of the part of the current introducing conductor which is opposite the opening. On this occasion, the member to which the above ceramics or/and material is fused is heated at least to the degree that its surface is wetted. Consequently, the current introducing conductor is appropriately sealed to the opening of the translucent ceramics discharge vessel without using any frit glass.

Therefore, the present invention achieves direct sealing without interposition of a heterogeneous material not contained in the material of the current introducing conductor or the opening of the translucent ceramics discharge vessel, for example, SiO₂ or Dy₂O₃; the heterogeneous material is, for example, frit glass conventionally used to seal the translucent ceramics discharge vessel. This improves the thermal shock resistance, high temperature resistance, and sealing strength of the seal part obtained.

Heating and melting of the sealing target part allows a solid solution of ceramics and a current introducing conductor substance to be relatively easily formed at a sealing interface. The formation of the solid solution further improves the thermal shock resistance, high temperature resistance, and sealing strength of the seal part.

According to the present invention, the excellent high temperature resistance of the seal part eliminates the need for an elongate small-diameter cylindrical part used to form a small gap called a capillary inside the translucent ceramics discharge vessel and between the translucent ceramics discharge vessel and the current introducing conductor to form a temperature gradient; the small-diameter cylindrical part is conventionally employed for the translucent ceramics discharge vessel. This serves to exert the effects described below. However, the present invention is not intended to exclude the use of a translucent ceramics discharge vessel comprising a small-diameter cylindrical part as required.

(1) The shock resistance and thermal shock resistance of the translucent ceramics discharge vessel are further improved.

(2) The omission of the small-diameter cylindrical part enables a reduction in the axial size of the translucent ceramics discharge vessel and thus the size of the high-pressure discharge lamp.

(3) A load on the tube wall in the translucent ceramics discharge vessel is increased to enable setting of its operating temperature at a value larger than that of the conventional high-pressure discharge lamp. This further increases the vapor pressure of the halide and thus light emission efficiency.

(4) Discharge medium entering the capillary becomes unnecessary, thus enabling the amount of discharge medium sealed to be reduced. The amount of impurities mixed in the discharge medium thus decreases to improve starting capability. This results in reduced turbidity and blackening, improved light flux maintenance rate, and reduced wear of electrodes. As a result, the lifetime characteristic of the high-pressure discharge lamp is improved. Further, a decrease in the amount of discharge medium sealed enables a reduction in the cost of the high-pressure discharge lamp.

[Other Possible Structures according to the Present Invention] Although not essential for the present invention, some or all of the structures described below may be provided as required to add corresponding functions to the high-pressure discharge lamp or to improve its performance.

(1) (Outer Tube) The high-pressure discharge lamp of the present invention can be configured to be lighted with the translucent ceramics discharge vessel exposed to the air. However, in summary, the translucent ceramics discharge vessel may be housed in an outer tube. The interior of the outer tube may be in a vacuum or may be filled with a gas or may be in communication with the air.

(2) (Reflector) The high-pressure discharge lamp of the present invention may be integrated with a reflector.

[Other Configurations of the Present Invention] The present invention includes configurations described below.

### Second Configuration

A second configuration of the present invention is the high-pressure discharge lamp of the first configuration in which the current introducing conductor is airtightly fused to the translucent ceramics discharge vessel by melting the ceramics at least in the opening of the translucent ceramics discharge vessel.

In the second configuration, the ceramics at least in the opening are heated and melted to stick well to the current introducing conductor inserted into the opening. The melted ceramics are then cooled and solidified to join and seal the current introducing conductor to the melted area of the ceramics in the opening. This closes the opening to seal the translucent ceramics discharge vessel.

The expression “the ceramics at least in the opening are melted” means that when the current introducing conductor is sealed to the opening, it is only necessary that the ceramics in the opening are melted to contribute to the sealing. This expression also means that not only the ceramics but also the surface of the current introducing conductor are melted at the same time. The opening can be more appropriately stuck to the current introducing conductor by diffusing the metal of the current introducing conductor in the joint between the current introducing conductor and the ceramics in the opening.

### Third Configuration

A third configuration of the present invention is the high-pressure discharge lamp of the first configuration in which a part of the current introducing conductor which is opposite at least the opening of the translucent ceramics discharge vessel comprises cermet.

In the third configuration, the cermet may or may not be conductive. In the latter case, the current introducing conductor may be divided into a part that mainly provides a conductive function and a part that mainly provides a sealing function so that the sealing function part can be composed of a cermet that is nonconductive or less conductive, whereas the conductive function part can be composed of metal or a conductive cermet.

Consequently, in the third embodiment, the cermet part can be used to seal the current introducing conductor to the opening of the translucent ceramics discharge vessel. When the ceramics constituting the cermet have the same characteristics as those of the ceramics constituting the translucent ceramics discharge vessel and the metal constituting the cermet is, for example, molybdenum, tungsten, or niobium, the cermet has a coefficient of thermal expansion close to that of the translucent ceramics discharge vessel. The cermet can thus stick well to the translucent ceramics discharge vessel. This enables the formation of a proper seal part not subject to any cracks. Therefore, proper sealing is achieved even with the relatively large grain size of the translucent ceramics.

A cermet of molybdenum or tungsten and ceramics does not react to a discharge medium such as niobium. Such a cermet may thus be partly exposed to the discharge space. Consequently, even when connected to the tungsten part of the electrode or current introducing conductor, the cermet part is unlikely to be cracked.

In contrast, if niobium is used for the seal part of the current introducing conductor, when the end of the seal part is exposed to the discharge space, the niobium reacts readily to the discharge medium and thus lasts shorter. Thus, the prior art covers the surface of the niobium in the discharge space with frit glass. However, if the frit glass passes beyond the niobium and covers even the tungsten or molybdenum part connected to the niobium, cracks are prone to occur owing to the difference in the coefficient of thermal expansion.

Moreover, the coefficient of thermal expansion of the cermet is also close to that of the metal, thus allowing the tungsten or molybdenum part to be connected to the leading end of the cermet which is closer to the discharge space. This allows the electrodes to be properly supported.

### Fourth Configuration

A fourth configuration of the present invention is the high-pressure discharge lamp of the third configuration in which the current introducing conductor comprises a metal bar part located adjacent to the cermet part and withdrawn into at least a portion of the cermet part.

In the fourth configuration, the metal bar may be located in one or both of the discharge space and external space. If the metal bar is located in the discharge space, the leading end part of the metal bar projects from the cermet part to support the electrodes. If the metal bar is located in the external space, the base end part of the metal bar is exposed from the cermet part and functions to support an arc tube and to supply electricity to the arc tube.

With respect to the extent to which the metal bar sinks in the cermet part, the metal bar may or may not penetrate the cermet part.

In the fourth configuration, the conductivity of the cermet part can be offered at least mainly by the metal bar part. Consequently, even if the metal bar does not penetrate any area, the contents of the ceramics and metal can be set, for the entire cermet part, within ranges optimum for sealing. This makes it possible to further suppress the occurrence of cracks.

Cermet generally melts more readily than metal alone. Consequently, even if the cermet part is softened by the heat for sealing, the metal bar part can maintain the predetermined shape of the functional part exposed to the exterior for power supply. This enables heating conditions for sealing to be optimized by, for example, setting a higher temperature.

If the metal bar penetrates the cermet part, the cermet part need not be conductive; conductivity can be offered by the metal part. Consequently, the cermet part may be substantially nonconductive. This enables the coefficient of thermal expansion of the cermet part to be optimally designed. Further, even if the end of the cermet part, which is likely to become hot during heating, is softened earlier, the penetrating metal bar makes it possible to inhibit an unwanted tilt of an electrode mount without any special support. The electrode mount is a structure integrally connected to the current introducing conductor by welding or the like in advance before sealing the current introducing conductor and electrodes.

On the other hand, if the metal bar does not penetrate the cermet part, the area not penetrated by the metal bar ensures the airtightness of the current introducing conductor. This eliminates the need to maintain the airtightness between the cermet part and the metal bar penetrating the cermet part. Thus, the relatively lower wettability of the cermet does not pose any problems. This enables the use of a properly meltable cermet.

### Fifth Configuration

A fifth configuration of the present invention is the high-pressure discharge lamp of the third or fourth configuration in which an unsealed part formed between the cermet part of the current introducing conductor and the opening of the translucent ceramics discharge vessel has an unsealed part average gap of 20 to 200 μm.

The unsealed part average gap is defined as follows. When a seal part is formed between the translucent ceramics discharge vessel and the cermet part, an area adjacent to the seal part remains unsealed. This area is called an unsealed part, and the average value of the size of a gap in the unsealed part is called the unsealed part average gap.

The fifth configuration of the present invention specifies a gap required to provide a proper seal between the cermet part and the opening of the translucent ceramics discharge vessel. The unsealed part is a residual area in which the seal part is not formed between the cermet part and the opening over the entire length of the cermet part. Accordingly, the unsealed part gap indicates the gap between the inner surface of the opening of the translucent ceramics discharge vessel and the cermet part inserted into the opening.

An unsealed part average gap of less than 20 μm makes it difficult to insert the electrode mount unless a variation in the thickness of inserted part of the electrode mount is minimized; the inserted part is inserted into the opening of the translucent ceramics discharge vessel. In this case, during sealing, the cermet part expands earlier to fill the gap, thus making the opening readily broken by stress.

In contrast, an unsealed part average gap of more than 200 μm increases the time required to stick and join the opening and cermet part to each other during sealing. This causes the cermet to melt excessively and flow out, thus making it difficult to maintain a cross-sectional area required to provide a required conductivity and a sufficient current capacity.

On the other hand, the average distance of the unsealed part along the tube axis is preferably at least 0.1 mm. An average distance of less than 1 mm facilitates sealing of even the molybdenum or tungsten part connected to the cermet. This reduces the reliability of the high-pressure discharge lamp. Sealing even this part disadvantageously results in the likelihood of cracking, disengagement of cermet from the metal such as molybdenum or tungsten as a result of a thermal shock during melting, or a reduced strength.

### Sixth Configuration

A sixth configuration of the present invention is the high-pressure discharge lamp of the first configuration in which the current introducing conductor comprises a cup made of a thin, halogen-resistant metal and which covers a niobium part that is opposite at least the opening of the translucent ceramics discharge vessel and a leading end of the niobium part which is located in the translucent ceramics discharge vessel.

The sixth embodiment specifies the configuration in which if the niobium part is sealed to the opening of the translucent ceramics discharge vessel, the niobium is not exposed to the discharge space.

If niobium is used for the seal part of the current introducing conductor, the niobium part closer to the discharge space needs to be covered with a halogen-resistant material in order to inhibit the niobium from contacting the discharge medium in the discharge space.

The prior art uses frit glass for sealing and advances it to the leading end of the niobium part exposed to the discharge space so as to cover the leading end.

In contrast, the present aspect uses the cup made of the thin, halogen-resistant metal to cover the leading end of the niobium part.

In the sixth configuration, the current introducing conductor may be composed of a niobium part, a cermet part connected to the niobium part, and/or a halogen-resistant metal part or only of the niobium part. If the current introducing conductor is composed only of the niobium part, the base end of the electrode shaft part may be connected to the leading end of the niobium part.

A material for the cup may be any halogen-resistant metal but is preferably molybdenum. The cup is thin, and if the material is molybdenum, the thickness is preferably between 2 and 60 μm in order to offer desired stretching properties and halogen barrier properties. The optimum range of the thickness is between 5 and 25 μm. A thickness of less than 2 μm results in a cup which is too thin to assemble and which is subject to cracking owing to softening during melting. A thickness of more than 60 μm leads to degraded stretching properties, release of the cup from the niobium part, or stress cracks in the opening or current introducing conductor.

A preformed cup may be placed on the leading end of the niobium part and then joined to the leading end using a high-pressure press machine. Alternatively, a cup may be formed by tightly attaching molybdenum directly to the leading end of the niobium part using known bonding means such as plating, deposition, or ion plating. Alternatively, a molybdenum foil may be placed in a mold and the niobium part may be pushed in the mold so as to form a cup by molding, while joining it to the leading end of the niobium part.

The sixth configuration covers the niobium part exposed to the discharge space with the cup made of the thin, halogen-resistant metal. This makes it possible to inhibit the reaction between the halide and niobium in the discharge medium without using frit glass as in the prior art.

### Seventh Configuration

A seventh configuration of the present invention is the high-pressure discharge lamp of the first configuration in which the current introducing conductor comprises a niobium part that is opposite at least the opening of the translucent ceramics discharge vessel, and a sealing material comprising a niobium base material and a film made of a material of the same quality as that of the translucent ceramics discharge vessel, the film being attached to at least one surface of the niobium base material, the sealing material being placed outside an opening end of the translucent ceramics discharge vessel to form a seal between the opening of the translucent ceramics discharge vessel and the current introducing conductor.

Like the sixth configuration, the seventh configuration uses the niobium part of the current introducing conductor for sealing. However, in the seventh configuration, the sealing material is melted outside the opening and advanced through the opening up to a sealing target part for sealing, as in the case where a conventional frit glass is used.

As is the case with the sixth aspect, the current introducing conductor may be composed of a niobium part, a cermet part connected to the niobium part, and/or a halogen-resistant metal part or only of the niobium part. If the current introducing conductor is composed only of the niobium part, the base end of the electrode shaft part may be connected to the leading end of the niobium part.

The sealing material is a structure composed of a plurality of layers. The sealing material is composed of the base material and the film made of the material of the same quality as that of the translucent ceramics discharge vessel. The base material may be a niobium foil having a thickness of about 0.1 mm. The film made of the material of the same quality as that of the translucent ceramics discharge vessel is an alumina film if, for example, the translucent ceramics discharge vessel consists of translucent alumina ceramics. The film conveniently has a film thickness of about 0.1 mm. The film made of the material of the same quality as that of the translucent ceramics discharge vessel is formed on one or both of surfaces of the base material. Film forming means may be known film producing means such as a PVD process (Physical Vapor Deposition process) or a CVD process (Chemical Vapor Deposition process), including coating, plating, and vacuum deposition.

The present aspect carries out sealing as follows. First, the translucent ceramics discharge vessel is placed so that its tube axis extends in a vertical direction. The electrode mount is then inserted into the translucent ceramics discharge vessel through its opening, located at the top. The sealing material is placed on the opening and around the externally projecting part of the current introducing conductor. The sealing material and the sealing target part are heated using heating means, for example, a laser. When the heating raises the temperature to melt the sealing material, gravity causes the sealing material to advance through the gap between the inner surface of the opening of the translucent ceramics discharge vessel and the niobium part of the current introducing conductor. When the heating is stopped to lower the temperature, the sealing material advanced in the gap is solidified to form a seal. In this case, if the ceramics in the opening and/or the surface of the current introducing conductor is softened or melted and fused to the sealing material, a solid solution id formed at the sealing interface. This results in a more appropriate seal.

The seventh configuration enables the adoption of a manufacture method of simultaneously heating the opening of the translucent ceramics discharge vessel and the sealing material. This enables proper heat absorption even with a YAG or CO₂ laser. Therefore, the heating can be carried out quickly to finish the sealing operation in a short time.

Further, the heating for sealing can be carried out along the tube axis at the position where the translucent ceramics discharge vessel is placed upright. This makes it possible to execute a sealing process in a cylindrical, small, and light pressure-resistant box. The size and cost of the sealing facility can thus be reduced.

The seventh configuration also eliminates the need to dispose a rotary mechanism in the pressure-resistant box. This significantly reduces the amount of impurities mixed into the translucent ceramics discharge vessel as a result of atmosphere contamination.

The seventh configuration also improves sealing uniformity and stability and thus the reliability of the seal part.

### Eighth Configuration

An eighth configuration of the present invention is the high-pressure discharge lamp of the first configuration in which the translucent ceramics discharge vessel comprises an opening having a tapered part with a diameter increasing toward the exterior, and in which the current introducing conductor comprises a tapered part inserted into the opening of the translucent ceramics discharge vessel, and at least a portion of the tapered part which is opposite the tapered part of the opening fits the opening.

In the eighth configuration, the tapered part is formed on the inner surface of the opening of the translucent ceramics discharge vessel; the tapered part is located in at least a part of the opening which is closer to the exterior and is shaped like a cone with a diameter increasing toward the exterior.

In the current introducing conductor, a material for the sealing part may be any substance such as niobium, cermet, or molybdenum which has a coefficient of thermal expansion close to that of the ceramics in the opening of the translucent ceramics discharge vessel and is not particularly limited. However, the current introducing conductor has the tapered part formed in at least an axial portion of the sealing target part and shaped like a cone with its diameter increasing toward the exterior of the opening so as to fit the tapered part of the opening.

The tapered parts of the opening of the translucent ceramics discharge vessel and of the seal part of the current introducing conductor are formed to be sealed with their surfaces in contact with each other when the electrodes are located at predetermined positions along the tube axis with their centers located on the tube axis.

In the eighth configuration, the current introducing conductor is inserted into the opening of the translucent ceramics discharge vessel up to the position where it is stopped. This sets the distance between the electrodes at a designed value and centers the electrodes on the tube axis. The eighth configuration therefore facilitates positioning of the current introducing conductor and assembly of the electrode mount on the translucent ceramics discharge vessel.

When the tapered part is formed in the sealing target part, the area of the sealing part to which heat is transferred is larger than that of a sealing part parallel to the tube axis. This increases the quantity of heat transferred, thus allowing the sealing target part to be readily melted.

If a laser is used as means for heating the sealing target part, a lens system focuses emitted laser beams on the sealing target part. In this case, more efficient heating can be achieved by increasing the focal angle of the laser beams and the angle of the tapered part.

Moreover, the sealing can be achieved by heating along the tube axis of the translucent ceramics discharge vessel placed so that the tube axis extends in the vertical direction. This has the same advantages as those described for the seventh configuration.

### Ninth Configuration

A ninth configuration of the present invention is the high-pressure discharge lamp of the first configuration in which a part of the current introducing conductor which is opposite the inner surface at least of the opening of the translucent ceramics discharge vessel comprises a conductive substance bar, and a sealing material having a niobium layer covering a peripheral surface of the conductive substance bar and a layer of a material of the same quality as that of the translucent ceramics discharge vessel which layer covers the outer surface of the niobium layer, and in which the seal part between the opening of the translucent ceramics discharge vessel and the current introducing conductor is formed by the fusion at least of the sealing material.

In the ninth configuration, a material for the conductive substance bar is not particularly limited. A halogen-resistant metal (for example, molybdenum or tungsten), niobium, cermet, or the like may be used to form a part of the conductive substance bar which is opposite the inner surface at least of the opening of the translucent ceramics discharge vessel, in other words, the sealing target part. However, with niobium, a part of the conductive substance bar which is exposed to the discharge space needs to be covered with the halogen-resistant substance, for example, alumina or molybdenum. In this case, the sixth configuration of the present invention can be used.

The sealing material is disposed so as to cover the periphery of the sealing target part of the conductive substance bar. The sealing material is composed of the niobium layer, located closer to the surface of the conductive substance bar, that is, in the lower part of the conductive substance bar, and the layer of the material of the same quality as that of the translucent ceramics discharge vessel, for example, alumina, which layer is stacked on the niobium layer so as to cover its entire surface.

One sealing material or plural sealing materials as required may be sequentially stacked around the sealing target part of the conductive substance bar.

The niobium layer and the layer of the material of the same quality as that of the translucent ceramics discharge vessel are both desirably formed to a layer thickness of about 1 to 500 μm.

The niobium layer and the layer of the material of the same quality as that of the translucent ceramics discharge vessel may be formed using known film producing means such as the PVD process (Physical Vapor Deposition process) or CVD process (Chemical Vapor Deposition process), including coating, plating, and vacuum deposition.

In the ninth configuration, the sealing material of the stacked structure is formed around the periphery of the sealing target part of the conductive substance bar. Since the sealing material is shaped like a thin film during heating, it readily absorbs heat and its temperature increases quickly. Consequently, the sealing material suitably constitutes a start point for melting. This allows a sealing part to be formed in a relatively short time. The seal is formed by fusion mostly of the sealing material or melting of the constituents of the ceramics or current introducing conductor in the opening triggered by melting of the sealing material. Any of the above arrangements enables the proper sealing part to be formed.

The ninth configuration also enables a plurality of sealing materials to be stacked as required. Thus, even if the conductive substance in the sealing target part of the current introducing conductor is a halogen-resistant metal, a seal part can be formed which absorbs stress resulting from the difference in the coefficient of thermal expansion between the halogen-resistant metal and the translucent ceramics. The ninth configuration is therefore particularly preferable.

Moreover, the sealing material is formed of the niobium layer and the layer of the material of the same quality as that of the translucent ceramics discharge vessel. Accordingly, forming a sealing part by fusion at least of the sealing material allows a solid solution of the sealing material component to be easily formed at the interface of the sealing part. The formation of the solid solution increases the thermal shock resistance of the sealing part formed.

### Tenth Configuration

A tenth configuration of the present invention is the high-pressure discharge lamp of the first configuration in which a part of the current introducing conductor which is opposite at least the opening of the translucent ceramics discharge vessel comprises a conductive substance bar, and a sealing material including a layer of a material of the same quality as that of the translucent ceramics discharge vessel which layer is attached to a peripheral surface of the conductive substance bar, and a niobium layer formed on the above layer, and in which the seal part between the opening of the translucent ceramics discharge vessel and the current introducing conductor is formed by the fusion at least of the sealing material.

The tenth configuration is the same as the ninth configuration except that the positional relationship between the niobium layer and the layer of the material of the same quality as that of the translucent ceramics discharge vessel is opposite to that in the ninth embodiment, both layers constituting the sealing material.

The tenth configuration exerts effects basically similar to those of the ninth configuration. However, since the niobium layer is formed on the layer of the material of the same quality as that of the translucent ceramics discharge vessel, even if the sealing target part of the current introducing conductor is niobium, the sealing part forms a thin-film structure of plural layers which absorbs heat quickly. Therefore, the ninth configuration is particularly preferable when the sealing target part of the current introducing conductor is niobium.

### Eleventh Configuration

An eleventh configuration of the present invention is the high-pressure discharge lamp of the first configuration in which the translucent ceramics discharge vessel consists of translucent polycrystalline alumina ceramics.

The eleventh configuration specifies the most practical component of the translucent ceramics discharge vessel.

### Twelfth Configuration

In a twelfth configuration of the present invention, the translucent polycrystal alumina ceramics have an average crystal grain size of at most 4 μm at least in the opening.

The twelfth configuration specifies the component of the translucent ceramics discharge vessel which is preferable for forming a sealing part by the fusion of the ceramics in the opening of the translucent ceramics discharge vessel or/and the material of the same quality as that of the material of the part of the current introducing conductor which is opposite the opening.

### Thirteenth Configuration

In a thirteenth configuration of the present invention, a part of the current introducing conductor which is opposite at least the opening of the translucent ceramics discharge vessel is composed of cermet. The current introducing conductor comprises a front layer on an outer peripheral surface of the cermet part which layer consists mainly of a material of the same quality as that of the translucent ceramics discharge vessel. The seal part between the opening of the translucent ceramics discharge vessel and the current introducing conductor is formed by melting at least the surface layer and the opening of the translucent ceramics discharge vessel.

In the thirteenth configuration, the surface layer formed on the outer peripheral surface of the cermet consists of the material of the same quality as that of the ceramics in the opening of the translucent ceramics discharge vessel. This eliminates the difference in the coefficient of thermal expansion between the opening of the translucent ceramics discharge vessel and the surface layer of the cermet part of the current introducing conductor. The seal part is formed between the opening and the cermet part by converting at least the opening and surface layer into a solid solution. This results in a reliable, proper seal, thus further suppressing damage to or leakage from the seal part caused by a heat shock resulting from lighting of the high-pressure discharge lamp.

The material of the same quality is preferably exactly the same as the ceramics. However, the material of the same quality may contain a small amount of subcomponent not contained in the ceramics to the extent that the above effects of the present aspect are not essentially lost. The allowable amount of subcomponent contained in the material is such that for example, the constituent metal of the cermet meets the above conditions.

The following definition applies to the formation of a seal part by converting at least of the surface layer and the opening of the translucent ceramics discharge vessel into a solid solution: the formation includes an aspect in which the opening and surface layer are converted into a solid solution and an aspect in which the cermet part, surface layer, and opening are converted into a solid solution.

In the thirteenth configuration, means for forming a surface layer on the outer peripheral surface of the cermet is not particularly limited. For example, a strong acid is used to remove the cermet-constituting metal deposited on the outer peripheral surface of the cermet part to leave the cermet-constituting ceramics. This results in a surface layer made of the material of the same quality as that of the ceramics in the opening of the translucent ceramics discharge vessel. Further, if the translucent ceramics discharge vessel consists of translucent alumina ceramics and the ceramics in the cermet part consist of alumina, the following method can be used to form a surface layer made of the material of the same quality as that of the ceramics in the opening of the translucent ceramics discharge vessel. Known film producing means such as vacuum deposition or sputtering is appropriately selectively used to form an aluminum film on the outer peripheral surface of cermet part of the current introducing conductor. An anodic oxidation process is then executed to oxidize the aluminum film to form an alumina layer.

Heating means for forming a seal part is preferably a laser, optimally a YAG laser. If the sealing target part is irradiated with laser beams, the focus of the laser beams is preferably positioned about 5 to 10 mm behind the sealing target part so that the sealing target part is out of focus. This allows laser energy to be appropriately dispersed to heat the sealing target part over a wide area at a time. Consequently, cracking resulting from rapid heat generation can be prevented, thus facilitating the sealing operation while enabling the formation of a proper seal part.

At the time of laser irradiation, the translucent ceramics discharge vessel and current introducing conductor are preferably rotated at several 10 s of rpm to achieve uniform sealing around the tube axis. In this case, generation of impurities in the translucent ceramics discharge vessel can be effectively suppressed by employing, as a rotation mechanism, a rotation introducing terminal that uses a magnetic fluid to make a rotating part airtight, to water-cool the entire rotating part.

It is not always possible to definitely determine whether or not the surface layer 2c is present inside the seal part. However, since the surface layer 2c is formed over an area that is longer than the seal part along the tube axis, the opposite ends of the surface layer 2c along the tube axis remain unsealed. Accordingly, if the surface layer is formed in the unsealed parts, it can be sufficiently assumed that the twelfth aspect has been implemented in which the front layer 2 is present at the time of sealing and in which a seal part is formed via the surface layer 2c.

A high-pressure discharge lamp operating apparatus of the present invention is characterized by comprising the high-pressure discharge lamp of the present invention, and a lighting circuit that lights the high-pressure discharge lamp.

In the present invention, the lighting circuit may have any configuration. The lighting circuit may be based on either AC or DC lighting scheme. For AC lighting, an electronic lighting circuit can be constructed which consists mainly of, for example, an inverter. A DC-to-DC converter such as a step-up or step-down chopper can be added to a DC power source connected to between input terminals of the inverter, as required. For DC lighting, an electronic lighting circuit can be constructed which consists mainly of the DC-to-DC converter.

An illuminating apparatus of the present invention is characterized by comprising an illuminating apparatus main body, the high-pressure discharge lamp of the present invention disposed in the illuminating apparatus main body, and a lighting circuit that lights the high-pressure discharge lamp.

In the present invention, the illuminating apparatus is a concept including all apparatuses using the high-pressure discharge lamp as a light source. Examples of the illuminating apparatus include various outdoor and indoor lighting fixtures, automotive headlamps, image or video projecting apparatuses, marker lamps, signal lamps, indicator lamps, chemical reaction apparatuses, and inspection apparatuses.

The illuminating apparatus main body corresponds to the illuminating apparatus excluding the high-pressure discharge lamp and lighting circuit.

The lighting circuit may be located away from the illuminating apparatus main body.

### BRIEF DESCRIPTION OF THE DRAWINGS

FIG. 1 is a front view of a metal halide lamp for an automotive headlamp as a first embodiment of a high-pressure discharge lamp according to the present invention;

FIG. 2 is an enlarged sectional view of an arc tube as the first embodiment;

FIG. 3 is a conceptual drawing showing a second embodiment of a high-pressure discharge lamp according to the present invention;

FIG. 4 is a sectional view of an arc tube according to a third embodiment in the high-pressure discharge lamp of the present invention;

FIG. 5 is a sectional view of an arc tube according to a fourth embodiment in the high-pressure discharge lamp of the present invention;

FIG. 6 is a partly cutaway sectional view of an arc tube according to a fifth embodiment in the high-pressure discharge lamp of the present invention;

FIG. 7 is a sectional view of an arc tube according to a sixth embodiment in the high-pressure discharge lamp of the present invention;

FIG. 8 is a sectional and partly enlarged perspective view of an arc tube according to a seventh embodiment in the high-pressure discharge lamp of the present invention;

FIG. 9 is a sectional view of an arc tube according to an eighth embodiment in the high-pressure discharge lamp of the present invention;

FIG. 10 is an enlarged sectional view of vicinity of a seal part;

FIG. 11 is a sectional view of an arc tube according to a ninth embodiment in the high-pressure discharge lamp of the present invention and a horizontally and vertically sectional view of essential part of the arc tube;

FIG. 12 is a schematic sectional view of essential part of a current introducing conductor and a sealing material according to a tenth embodiment in the high-pressure discharge lamp of the present invention;

FIG. 13 is a sectional view of an arc tube according to an eleventh embodiment in the high-pressure discharge lamp of the present invention and a horizontally sectional view of essential part of the arc tube;

FIG. 14 is a schematic sectional view illustrating a process of sealing a high-pressure discharge lamp according to a twelfth embodiment in the high-pressure discharge lamp of the present invention;

FIG. 15 is a schematic diagram of an electrode mount according to the twelfth embodiment;

FIG. 16(a) is a surface photograph of a sealing substance bar taken before formation of a front layer, and FIG. 16(b) is a surface photograph of the surface layer according to the twelfth embodiment;

FIG. 17 is a block circuit diagram showing an embodiment of a high-pressure discharge lamp operating apparatus of the present invention; and

FIG. 18 is a conceptual side view showing an automotive headlamp as an embodiment of an illuminating apparatus according to the present invention.

### DETAILED DESCRIPTION OF THE PREFERRED EMBODIMENTS

The present invention will be described below with reference to the drawings.

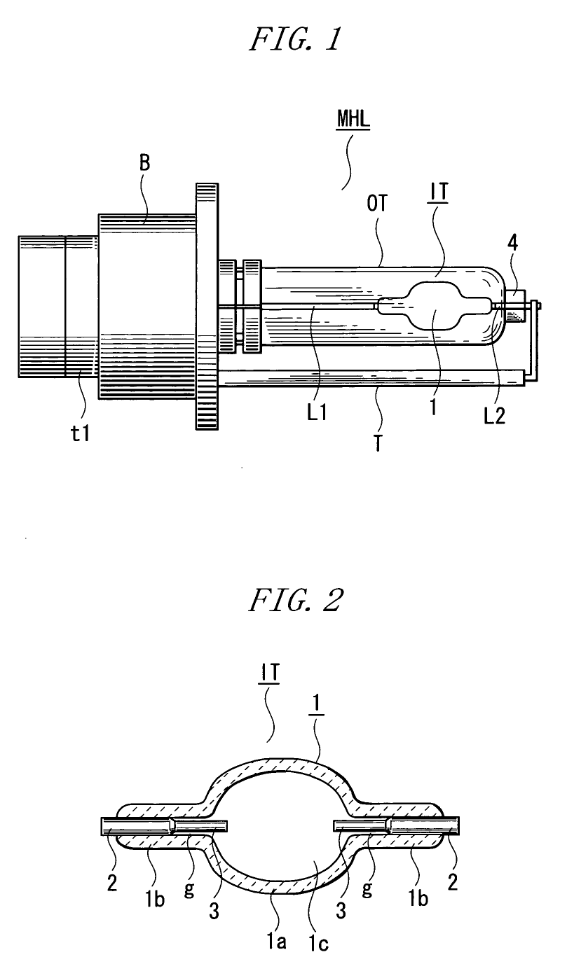

FIGS. 1 and 2 show a metal halide lamp for an automotive headlamp as a first embodiment in a high-pressure discharge lamp of the present invention. FIG. 1 is a front view of the entire lamp. FIG. 2 is an enlarged view of an arc tube. A metal halide lamp MHL for an automotive headlamp is composed mainly of an arc tube IT, leads L1 and L2, an insulating tube T, an outer tube OT, and a base B.

The arc tube IT consists of a translucent ceramics discharge vessel 1, a current introducing conductor 2, electrodes 3, and a discharge medium.

As shown in FIG. 2, the translucent ceramics discharge vessel 1 is formed by integrally molding translucent ceramics as a main material. The translucent ceramics discharge vessel 1 comprises a surrounding part 1a and a pair of openings 1b, 1b. The surrounding part 1a is obtained by molding a material into a hollow spindle shape with an almost uniform thickness and has a discharge space 1c formed inside; the discharge space 1c is shaped similarly to the surrounding part 1a. The discharge space 1c has an internal volume of at most about 0.05 cc. The paired openings 1b, 1b are each formed of a relatively short and thin cylindrical part extending integrally from the corresponding end of the surrounding part 1a along the tube axis.

The current introducing conductor 2 consists of a sealing metal bar and is inserted into each of the openings 1b of the translucent ceramics discharge vessel 1. The current introducing conductor 2 is sealed in the opening 1b by melting the ceramics at least in the opening 1b. Accordingly, the leading end of the current introducing conductor 2 is located in the opening 1b, whereas its base end is exposed from the translucent ceramics discharge vessel 1.

The electrode 3 consists of a tungsten wire and has a uniform diameter at its axially leading end, in its axially intermediate part, and at its axially base end. The leading end and intermediate part are partly exposed to the discharge space 1c. The electrode 3 is supported along the tube axis of the translucent ceramics discharge vessel 1 by connecting its base end to the leading end of the current introducing conductor 2 by welding. A short, small gap g, that is, a capillary, is formed between the intermediate part of the electrode 3 and an inner surface of the cylindrical part of the opening 1b; the gap g extends along the tube axis. However, the capillary is evidently shorter than that in a conventional high-pressure discharge lamp in which a translucent ceramics discharge vessel is sealed using frit glass.

The discharge medium consists of a halide of a luminous metal, a lamp voltage forming medium, and a rare gas. The lamp voltage forming medium consists of mercury or a lamp voltage forming halide that is a halide of metal that emits a smaller quantity of light in a visible region than a luminous metal owing to a high vapor pressure when it is present with a halide of a luminous metal.

The leading end of each of the leads L1 and L2 is connected to the base end of the corresponding current introducing conductor 2 by welding to support the arc tube IT. The lead L1 extends along the tube axis and into the base B, described later. The lead L1 is connected to a pin-like base terminal (not shown) disposed in the middle of the base. The lead L2 is folded back along the outer tube OT, described later in the intermediate part. The lead L2 is led into the base B and connected to a ring-like base terminal t1 disposed on an outer peripheral surface of the base B.

The insulating tube T consists of a ceramic tube that covers the lead L2.

The outer tube OT has an ultraviolet cut-off capability and has the arc tube IT housed inside. Reduced diameter parts 4 (only the right end is shown) at the opposite ends of the outer tube OT is welded to the lead L2 using glass. However, the interior of the outer tube OT is not airtight but is in communication with the air.

The base B conforms to standards for automotive headlamps and support the arc tube IT and outer tube OT so that the tubes extend along the center axis of the base B. The base B is removably installed in an automotive headlamp from its rear surface. To connect to a power supply-side lamp socket in installation, the base B comprises the ring-like base terminal t1, disposed on the cylindrical outer peripheral surface, and the pin-like base terminal, disposed in a recess so as to project in an axial direction from the center of the base; the recess is formed inside the cylindrical part of the base and has an open end.

### EXAMPLE 1

Translucent ceramics discharge vessel: integrally molded and made of translucent alumina ceramics, entire length: 16 mm,

Surrounding part: maximum inner diameter: 5 mm, thickness: 0.5 mm, and length: 6 mm,

Opening: inner diameter: 0.7 mm, thickness: 0.5 mm, and length: 5 mm

Current introducing conductor: Nb bar

Electrode: tungsten bar, inter-electrode distance: 4.2 mm

Discharge medium: halide of a luminous metal DyI₃—NdI₃—CsI=3 mg, lamp voltage forming halide ZnI₂=1 mg, rare gas Xel: 0.5 atm

Sealing method: rotating opening is externally irradiated with YAG laser to melt the ceramics in the opening of the translucent ceramics discharge vessel to seal the current introducing conductor to the opening.

Current characteristics: lamp power: 35 W, lamp voltage: 70 V

FIG. 3 is a conceptual drawing showing a second embodiment of the high-pressure discharge lamp of the present invention. In the figure, the same components as those in FIG. 2 are denoted by the same reference numerals and their description is omitted. In the second embodiment, the translucent ceramics discharge vessel 1 for the high-pressure discharge lamp is irradiated with laser light in the direction in which the opening 1b extends, that is, along the tube axis of the translucent ceramics discharge vessel 1. This seals the translucent ceramics discharge vessel together with the current introducing conductors inserted into the openings. This will be described below in detail.

The sealing method according to the second embodiment is characterized by using a YAG laser that is a kind of local heating means, as a heating source that melts the opening 1b and in that laser beams LB are applied so that an irradiation axis aligns with an almost central position of the current introducing conductor along the tube axis of the opening 1b and current introducing conductor 2.

In the second embodiment, the translucent ceramics discharge vessel 1 is not rotated but is stationary. The focus f of the laser beams LB from the YAG laser is set and irradiated at a position 2 to 10 mm from an end surface of the opening 1b toward the surrounding part 1a.

A sealing atmosphere may be at 5 to 40 atm. The gas in the atmosphere may be a filler rare gas under a predetermined pressure.

If the translucent ceramics discharge vessel 1 is composed of alumina ceramics and a YAG laser is used, a metal heat insulating tube is preferably installed so as to surround a sealing target part of the opening 1b.

According to the second embodiment of the present invention, when the direction in which the laser beams LB are emitted almost coincides with the tube axis direction of the translucent ceramics discharge vessel 1, an irradiation window of the laser beams LB and the translucent ceramics discharge vessel 1 align with each other on one axis. Consequently, in a light, small, cylindrical, simple, pressure-resistant box, the opening 1b of the translucent ceramics discharge vessel 1 can be sealed by a seal part s shown by a thick line and formed by sticking the melted ceramics of the opening 1b to the current introducing conductor 2. This sharply reduces apparatus costs and the mixture of impurities resulting from atmospheric contamination.

Further, the opening 1b can be uniformly heated in a circumferential direction in a short time. This reduces a sealing index time and thus a substantial apparatus price to half.

Moreover, the opening 1b is sealed more uniformly and stably, thus improving the reliability of the seal part.

In contrast, if the laser beam irradiation direction is perpendicular to the tube axis, when the operation is performed in a box in a lamp filler gas atmosphere with the translucent ceramics discharge vessel 1 being rotated, a rotary mechanism needs to be provided in the box. This is prone to contaminate the atmosphere. Further, if the atmosphere is at a high pressure equal to or higher than 5 atm, keeping the rotary unit airtight is difficult.

Even if the ceramics in the opening do not readily absorb laser energy, a metal heat insulating tube MT may be disposed as described above to absorb irradiation energy to raise the temperature. The metal heat insulating tube MT thus serves as a secondary heating source to heat the opening 1b as desired to achieve sealing. That is to say, the irradiation energy of the YAG laser is not easily absorbed by the alumina ceramics. This problem can be solved by placing the metal tube around the periphery of the opening to be melted. Compared to the omission of the metal heat insulating tube, this configuration can carry out equivalent heating using a laser unit with less power that is a fraction of that required in the omission case. Therefore, it can extremely reduce apparatus cost and improve the reliability of sealing because of enhanced uniformity in the axial direction.

Moreover, the focus f of the laser beams is appropriately offset from the end surface of the opening 1b toward the interior along the tube axis, that is, toward the surrounding part. This prevents only the end surface of the opening from being heated earlier and enables melting of a wide area spreading along the tube axis and in a radial direction. The reliability of sealing is thus improved.

On the other hand, replacing the YAG laser with a CO₂ laser enables irradiation energy to be directly absorbed by alumina ceramics. This makes it possible to achieve sealing with less power and to heat a position somewhat deeper than the surface. Consequently, the current introducing conductor can be sealed even if it is composed of a metal with a relatively low melting point. Thus, as the metal for the current introducing conductor, a metal with high sealing properties can be selected from a wide range of metals. This improves the reliability of sealing.

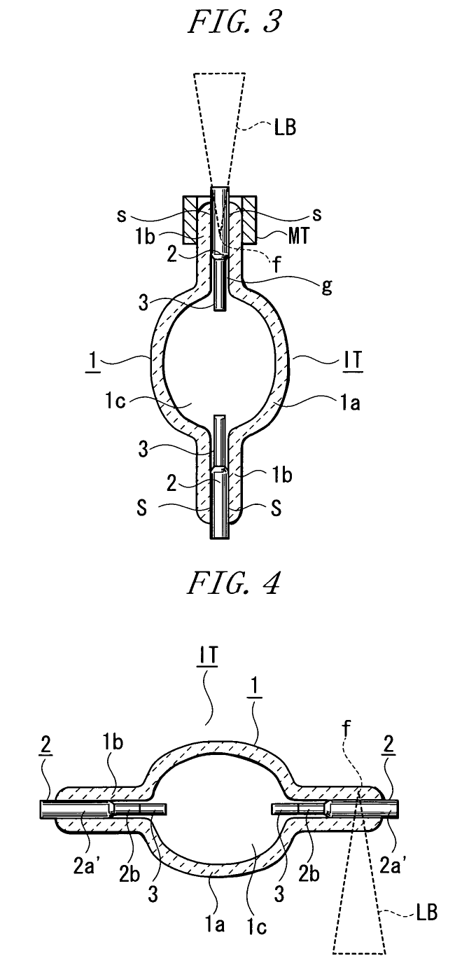

With reference to FIGS. 4 to 13, description will be given of a third to eleventh aspects for carrying out a second to ninth embodiments of the present invention. In the figures, the same components as those in FIG. 2 are denoted by the same reference numerals and their description is omitted.

FIG. 4 is a sectional view of an arc tube according to the third embodiment in the high-pressure discharge lamp of the present invention. The third embodiment carries out the second to fourth aspects of the present invention.

In the third embodiment, the current introducing conductor 2 has a series connection structure of a sealing substance bar 2a′ and a halogen-resistant metal bar 2b. The sealing substance bar 2a′ is a cermet that is a mixed sintered body of alumina and molybdenum.

The electrode 3 is welded to a leading end of the halogen-resistant metal bar 2b.

A sealing target part is located in the sealing substance bar 2a′, consisting of the cermet. The sealing target part is opposite a sealing target part of the opening 1b of the translucent ceramics discharge vessel 1. The gap between the sealing substance bar 2a′, consisting of the cermet, and the inner surface of the opening 1b is preset within the range of 20 to 200 μm.

The sealing target parts are heated by being irradiated with, for example, the laser beams shown by reference character LB, in a direction orthogonal to the tube axis to raise the temperature; the sealing target parts belong to the sealing substance bar 2a′, consisting of the cermet, and to the opening 1b of the translucent ceramics discharge vessel 1, which is opposite the above sealing target part. When the temperature reaches the melting point of the cermet, the cermet in the sealing substance bar 2a′ is first melted and fused to the sealing target part of the opening 1b. Provided that during the fusion process, the ceramics in the opening 1b are softened or melted to the degree that at least their surface is wetted, a more proper seal part is formed.

An unsealed part (not shown) is formed on that side of the sealing substance bar 2a′, consisting of the cermet, which is closer to the electrode 3; the unsealed part extends at least about 1 mm along the tube axis. In forming a seal part, the formation of the unsealed part makes it possible to avoid joining part of the halogen-resistant metal bar 2b directly to the opening 1b. If the halogen-resistant metal bar 2b is partly joined to the opening 1b during the formation of a seal part, a high thermal stress is induced by the difference in the coefficient of thermal expansion between the ceramics in the opening 1b and the halogen-resistant metal. The thermal stress acts on the seal part, which is thus prone to be cracked.

### EXAMPLE 2

The structure shown in FIG. 4 is used.

Current introducing conductor: cermet (Mo-alumina) bar of diameter 0.65 mm+Mo bar of diameter 0.3 mm

Electrode: W bar, inter-electrode distance: 3.0 mm

Seal part: welding mostly occurs in the cermet in the current introducing conductor. Instead of the cermet, the opening may be welded.

Unsealed part: average gap on the discharge space side: 0.05 mm, length along the tube axis: 1.5 mm

Rare gas: Xe at 0.5 atm

The other arrangements are the same as those in Example 1.

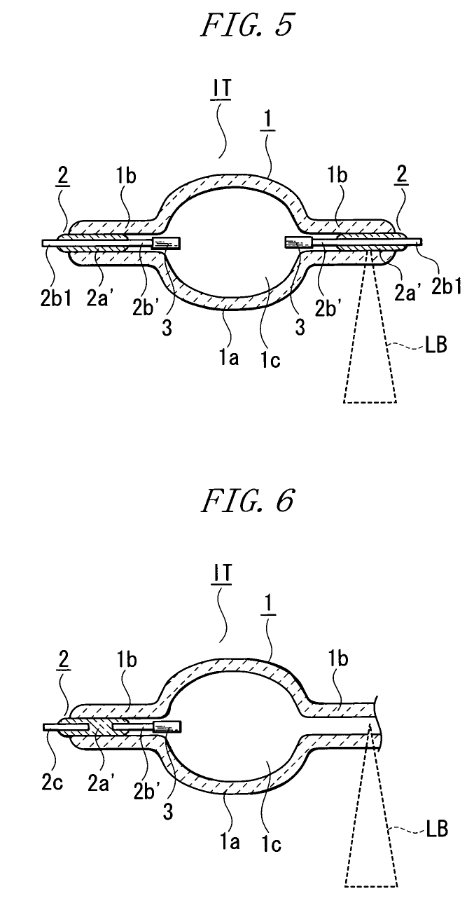

FIG. 5 is a sectional view of an arc tube according to a fourth embodiment in the high-pressure discharge lamp of the present invention. The fourth embodiment carries out the second to fourth aspects of the present invention.

In the third embodiment, the current introducing conductor 2 has the series connection structure of the sealing substance bar 2a′, consisting of the cermet, and the halogen-resistant metal bar 2b′. The halogen-resistant metal bar 2b′ penetrates the sealing substance bar 2a′, consisting of the cermet, with its base end 2b1 projecting out of the opening 1b.

In contrast, in the fourth embodiment, the conductivity of the current introducing conductor 2 is offered mainly by the halogen-resistant metal bar 2b′. Thus, the cermet in the sealing substance bar 2a′ employs an Mo-alumina mixture ratio for which the sealing properties are taken into account. This enables more appropriate sealing.

The base end 2b1 has a higher melting point than the sealing substance bar 2a′, consisting of the cermet, and is not softened and deformed when a seal part is formed.

### EXAMPLE 3

The structure shown in FIG. 5 is used.

Current introducing conductor: cermet (Mo-alumina, mixture ratio (mass %): 50 to 50) bar+Mo bar

Unsealed part: average gap: 0.05 mm, length along the tube axis: 1.5 mm

The other arrangements are the same as those in Example 2.

The average gap in the unsealed part is measured in an area which is adjacent to the seal part and which is not deformed in spite of sealing. The average gap is determined by reducing the difference between the inner diameter of opening of the translucent ceramics discharge vessel and the diameter of the current introducing conductor to half.

FIG. 6 is a partly cutaway sectional view of an arc tube according to the fifth embodiment in the high-pressure discharge lamp of the present invention. The fifth embodiment corresponds to a variation of the fourth embodiment and thus carries out the second to fourth aspects of the present invention.

The current introducing conductor 2 has the series connection structure of the sealing substance bar 2a′, consisting of the cermet, a niobium bar 2c, and the halogen-resistant metal bar 2b′. However, the niobium bar 2c and halogen-resistant metal bar 2b′ are partly withdrawn into in the sealing substance bar 2a, consisting of the cermet.

### EXAMPLE 4

The structure shown in FIG. 6 is used.

Current introducing conductor: Nb bar+cermet (Mo—Al₂O₃, mixture ratio (mass %): 50 to 50) bar+Mo bar

Unsealed part: average gap: 0.05 μm, length along the tube axis: 1.5 mm

The other arrangements are the same as those in Example 2.

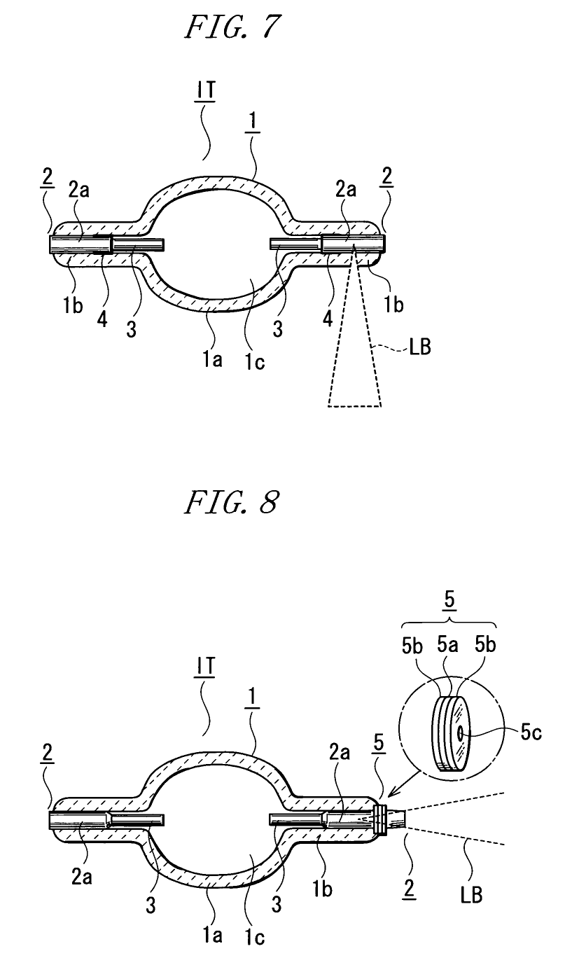

FIG. 7 is a sectional view of an arc tube according to the sixth embodiment in the high-pressure discharge lamp of the present invention. The sixth embodiment carries out the fifth aspect of the present invention.

In the sixth embodiment, the current introducing conductor 2 includes the sealing substance bar 2a consisting of a niobium bar. The leading end of the sealing substance bar 2a is covered with a cup 4 made of a thin, halogen-resistant metal.

According to the sixth embodiment, the niobium in the sealing substance bar 2a is covered with the cup 4. Thus, the niobium is not exposed to the discharge space 1c in the translucent ceramics discharge vessel 1. This makes it possible to inhibit the niobium from reacting with the halide of the discharge medium.

### EXAMPLE 5

The structure shown in FIG. 7 is used.

Current introducing conductor: Nb bar

Cup: Mo of thickness 20 μm

Electrode: W bar, inter-electrode distance: 3 mm

Seal part: formed mostly by welding of the niobium bar. Instead of the niobium bar, the ceramics in the opening may be melted.

FIG. 8 is a sectional view and a partly enlarged perspective view of an arc tube according to the seventh embodiment in the high-pressure discharge lamp of the present invention. The seventh embodiment carries out the sixth aspect of the present invention.

In the seventh embodiment, the current introducing conductor 2 is sealed to the opening 1b by welding the sealing material 5 placed outside the opening 1b of the translucent ceramics discharge vessel 1.

As shown in the perspective view, the sealing material 5 is shaped like a thin disk with a through-hole 5c formed in its central part. The sealing material 5 comprises a niobium base plate 5a and a film 5b of a material of the same quality as that of the translucent ceramics discharge vessel attached to the surface of the niobium base material 5a. Before sealing, the translucent ceramics discharge vessel 1 is placed so that the left side of FIG. 8 corresponds to its upper part and so that its tube axis extends in the vertical direction. Then, as shown in the figure, the through-hole 5c is inserted around a projecting part of the current introducing conductor 2 so that the sealing material 5 is placed on the end surface of the opening 1b.

To form a seal part, the translucent ceramics discharge vessel 1, current introducing conductor 2, and sealing material 5 are irradiated with the laser beams LB along the tube axis as shown in FIG. 8. The irradiation heats the sealing material 5, current introducing conductor 2, and opening 1b to raise their temperatures. At this time, the sealing material 5 is the first to reach and exceed its melting point and to melt. This is because the sealing material 5 has only a small heat capacity and the niobium base material 5a and the film 5b made of the material of the same quality as that of the translucent ceramics discharge vessel are both thin. The sealing material 5 melts and flows down through the gap between the opening 1b of the translucent ceramics discharge vessel 1 and the current introducing conductor 2. When the sealing material 5 reaches the sealing target part, the heating is stopped. The melted sealing material 5 flows down to the sealing target part, where it solidifies to form a seal part in the sealing target part.

The above sealing method is similar to the conventional sealing using frit glass. However, instead of using frit glass, the present sealing method achieves sealing by fusing the material of the same quality as that of the material of the translucent ceramics discharge vessel 1 or/and the part of the current introducing conductor 2 which is opposite the opening 1b.

### EXAMPLE 6

The structure shown in FIG. 8 is used.

Current introducing conductor: Nb bar

Sealing material: niobium base material of thickness 100 μm+Al₂O₃ film of thickness 100 μm on the opposite surfaces of the niobium base material

Seal part: formed mostly by fusing of the sealing material.

The other arrangements are the same as those in Example 5.

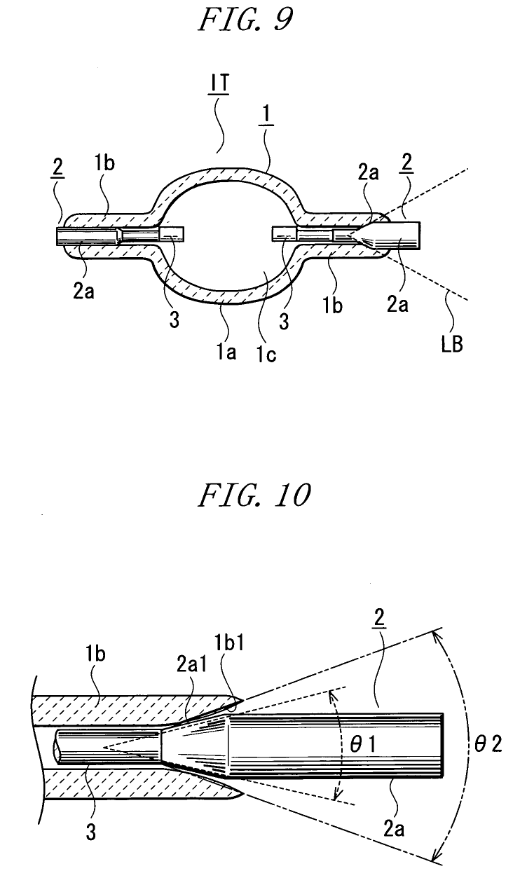

FIGS. 9 and 10 show an arc tube according to the eighth embodiment in the high-pressure discharge lamp of the present invention. FIG. 9 is a sectional view and FIG. 10 is an enlarged sectional view of vicinity of the seal part. The eighth embodiment carries out the seventh aspect of the present invention. Conical tapered parts 1b1 and 2a1 are formed in the opening 1b and current introducing conductor 2 in the seal part; the tapered parts 1b1 and 2a1 have a diameter increasing toward the exterior of the translucent ceramics discharge vessel 1.

In the eighth embodiment, heating is advantageously carried out along the tube axis as is the case with the seventh embodiment, shown in FIG. 8. Specifically, the interface between the sealing target parts can be easily and intensively heated by setting the angle θ1 between the tapered parts 1b1 and 2a1 almost equal to the angle θ2 through which the laser beams LB are applied. Further, the larger angle between the tapered parts 1b1 and 2a1 enables the sealing target part to be efficiently heated. The tapered parts 1b1 and 2a1 can also inhibit the unwanted inclination of the electrode mount.

### EXAMPLE 7

The structure shown in FIGS. 9 and 10 is used.

Opening: tapered part of angle 17.3° is formed on its inner surface.

Current introducing conductor: Nb bar with a tapered part of angle 17.3° formed in the sealing target part.

Seal part: formed mostly by fusing the ceramics in the opening.

The other arrangements are the same as those in Example 3.

FIG. 11 is a sectional view of an arc tube according to the ninth embodiment in the high-pressure discharge lamp of the present invention as well as a horizontally and vertically sectional view of essential part of the arc tube. The ninth embodiment carries out the eighth aspect of the present invention. The current introducing conductor 2 comprises a sealing material 6 around an outer peripheral surface of sealing target part of the conductive substance bar 2d.

In other words, the sealing material 6 is pre-attached to the sealing target part of conductive substance bar 2d of the current introducing conductor 2. A desired number of units of the sealing material 6 are stacked on the conductive substance bar 2d; a single unit of the sealing material 6 is composed of a niobium layer 6a and a layer 6b made of a material of the same quality as that of the translucent ceramics discharge vessel 1.

The seal part is formed mostly by fusing at least the sealing material 6.

### EXAMPLE 8

The structure shown in FIG. 11 is used.

Current introducing conductor: Mo bar

Sealing material: Stack of a niobium and Al₂O₃ layers of thickness about 0.1 mm

Seal part: formed mostly by fusing the sealing material.

The other arrangements are the same as those in Example 3.

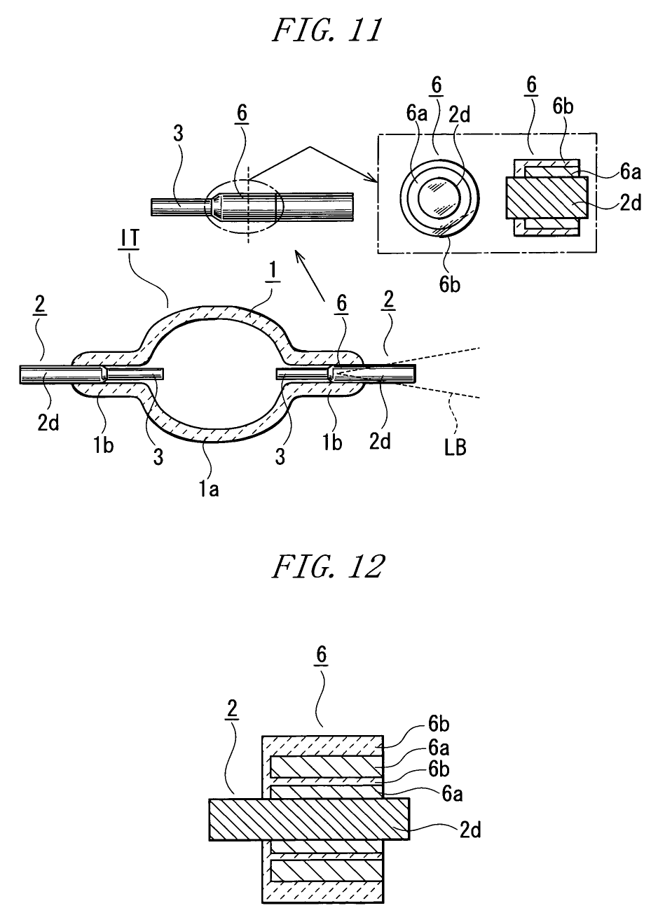

FIG. 12 is a schematic sectional view of essential part of a current introducing conductor and a sealing material according to the tenth embodiment in the high-pressure discharge lamp of the present invention. The tenth embodiment carries out a variation of the eighth aspect of the present invention. In this configuration, plural units of the sealing material 6 are stacked and attached to the outer peripheral surface of the current introducing conductor 2; a single unit of the sealing material 6 is composed of the niobium layer 6a and the layer 6b made of the material of the same quality as that of the translucent ceramics discharge vessel 1.

### EXAMPLE 9

The structure shown in FIG. 12 is used.

Current introducing conductor: Mo bar

Sealing material: stack of plural units each of a niobium and Al₂O₃ layers of thickness about 0.05 mm

Seal part: formed mostly by fusing the sealing material.

The other arrangements are the same as those in Example 3.

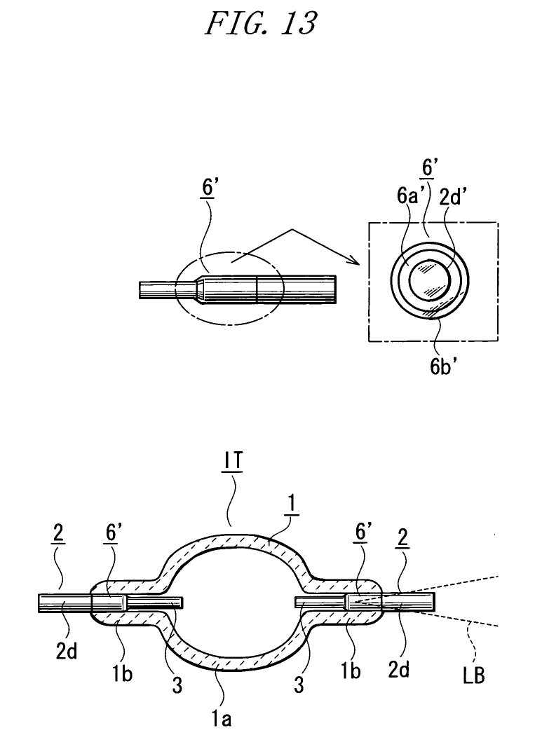

FIG. 13 is a sectional view of an arc tube according to the eleventh embodiment in the high-pressure discharge lamp of the present invention as well as a horizontally sectional view of essential part of the arc tube. The eleventh embodiment carries out the ninth aspect of the present invention. The current introducing conductor 2 comprises a sealing material 6′ around an outer peripheral surface of sealing target part of a conductive substance bar 2d′.

In other words, the sealing material 6′ is pre-attached to the sealing target part of conductive substance bar 2d′ of the current introducing conductor 2. A desired number of units of the sealing material 6′ are stacked on the conductive substance bar 2d′; a single unit of the sealing material 6 is composed of a layer 6a′ made of a material of the same quality as that of the translucent ceramics discharge vessel 1 and a niobium layer 6b′. The layer 6a′ made of a material of the same quality as that of the translucent ceramics discharge vessel 1 is stacked on the niobium layer 6b′ so as to cover the entire niobium layer 6b′.

### EXAMPLE 10

The structure shown in FIG. 13 is used.

Current introducing conductor: Nb bar

Sealing material: Stack of an Al₂O₃ and niobium layers of thickness about 0.1 mm

Seal part: formed mostly by fusing the sealing material.

The other arrangements are the same as those in Example 3.

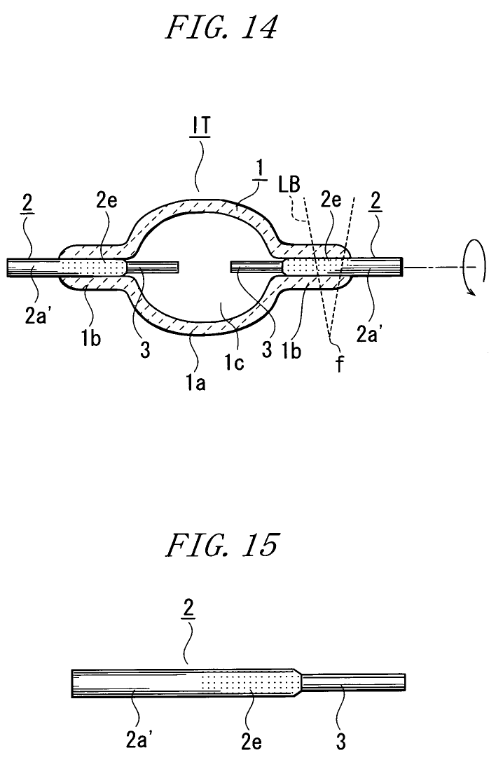

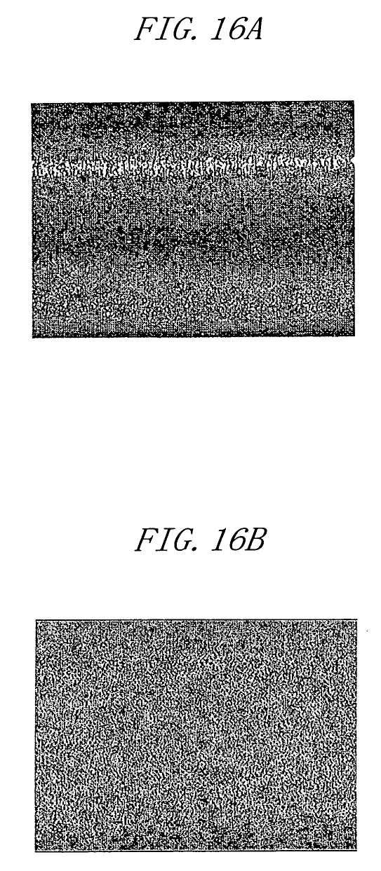

FIGS. 14 to 16 show a twelfth embodiment of the high-pressure discharge lamp of the present invention. FIG. 14 is a schematic sectional view of the high-pressure discharge lamp illustrating a process of sealing the translucent ceramics discharge vessel and current introducing conductor. FIG. 15 is a schematic perspective view of the electrode mount. FIG. 16(a) is a surface photograph of a sealing substance bar taken before formation of a surface layer. FIG. 16(b) is a surface photograph of the surface layer. The twelfth embodiment carries out the twelfth aspect of the high-pressure discharge lamp of the present invention. In FIGS. 14 and 15, the same components as those in FIG. 2 are denoted by the same reference numerals and their description is omitted.

In the twelfth embodiment, a surface layer 2c is formed around the outer peripheral surface of the sealing substance bar 2a′ of the current introducing conductor 2; the sealing substance bar 2a′ consists of cermet. The surface layer 2c consists of a material of the same quality as that of the ceramics in the opening 1b of the translucent ceramics discharge vessel 1. In the present embodiment, since the translucent ceramics discharge vessel 1 consists of translucent alumina ceramics, the surface layer 2c is composed mainly of alumina.

The current introducing conductor 2 and electrode 3 are connected together in series by means of welding and thus integrated together to constitute an electrode mount M. The electrode mount M is inserted through the opening 1b of the translucent ceramics discharge vessel 1 up to a predetermined position. The electrode mount M is then sealed as described later.

In the twelfth embodiment, the surface layer 2c is formed by using a strong acid to remove the cermet constituting metal deposited on the cermet surface of the sealing substance bar 2a′, while leaving only the cermet constituting ceramics. The strong acid is, for example, aqua regia (hydrochloric acid:nitric acid=3:1). The cermet part is immersed in the aqua regia for a predetermined time, for example, about 30 minutes. The cermet part is then washed with pure water and dried. This removes the moisture and impurities from the surface of the cermet part. The strong acid treatment leaves and exposes almost all alumina from the cermet surface of the sealing substance bar 2a′. The alumina constitutes the surface layer 2c.

In the twelfth embodiment, the translucent ceramics discharge vessel 1 has an average alumina crystal grain size of at most 4 μm, preferably at most 1 μm, more preferably at most 0.5 μm, at least in the opening. The cermet contains 5 to 60% of alumina.

The opening 1b of the translucent ceramics discharge vessel 1 and current introducing conductor 2 are sealed as described below. With the translucent ceramics discharge vessel 1 and electrode mount M being rotated together, the laser beams LB are emitted from a side of the tube axis so that the focus of the laser beams LB is positioned behind the sealing target part as shown in FIG. 14. This heats the sealing substance bar 2a′ and surface layer 2c of the current introducing conductor 2 as well as the opening 1b. The irradiation with the laser beams first causes the interior of the cermet part of the sealing substance bar 2a′ to absorb more heat. The surface layer 2c is then melted by the heat transferred from the cermet part of the sealing substance bar 2a′. The heat is further transferred to the opening 1b which is in contact with the front layer. This melts the entire sealing target parts, located over and under the surface layer 2c. Subsequently, the heating is ended to solidify the melted parts to form a seal part composed of a solid solution. Thus, in the seal part, the opening 1b and the sealing substance bar 2a′ of the current introducing conductor 2, located over and under the surface layer 2c, are converted into a solid solution to offer sufficient airtightness.

### EXAMPLE 11

The structure shown in FIG. 14 is used.

Translucent ceramics discharge vessel: integrally molded and made of translucent alumina ceramics, entire length: 15 mm,

Surrounding part: maximum inner diameter: 5 mm, thickness: 0.5 mm, and length: 6 mm,

Opening: inner diameter: 0.7 mm, thickness: 0.5 mm, and length: 5 mm

Current introducing conductor: sealing substance bar' is formed of the cermet (Mo—Al₂O₃=mass ratio of 1:1), with a front layer of a thin Al₂O₃ film formed around the outer peripheral surface of the cermet part.

Electrode: W bar welded to the leading end of the sealing substance bar', inter-electrode distance: 3.0 mm

Seal part: cermet part of the current introducing conductor, the front layer, and the ceramics in the opening are converted into a solid solution, which forms a seal part.

Discharge medium: DyI3-NdI3-CsI=3 mg, rare gas Xe: 0.5 atm

The other arrangements are the same as those in Example 3.

FIG. 16(a) is a photograph of surface of the cermet part taken before a strong acid treatment in the eleventh embodiment. FIG. 16(b) is a photograph of the surface layer 2c formed by the strong acid treatment. FIG. 16(b) shows that the surface layer 2c has been formed by removing the conductive metal from the surface layer in the cermet part, while leaving only alumina.

Now, description will be given of a thirteenth embodiment of the high-pressure discharge lamp of the present invention. The thirteenth embodiment also carries out the twelfth aspect but uses different means for forming a surface layer 2c of the current introducing conductor 2.

In the thirteenth embodiment, the surface layer 2e consists of an alumina layer formed by subjecting an aluminum film to anode oxidation. In the thirteenth embodiment, the aluminum film may have a film thickness of about 1 to 10 μm. An aluminum film is attached to the outer peripheral surface of the cermet part. The cermet part of the current introducing conductor 2 is immersed in a sulfuric electrolyte of 25 mass % at a liquid temperature of 20° C. An anodic oxidation treatment is then carried out by passing a current of current density 1A/dm² through the cermet part of the current introducing conductor 2 for a several minutes. The current introducing conductor 2 is then washed with pure water and dried. This removes the impurities and moisture from the surface of the current introducing conductor 2. The aluminum film is thus oxidized to form an alumina film corresponding to the surface layer 2e around the outer peripheral surface of the cermet part. In this case, the alumina film in the surface layer 2e is porous.

The electrode mount M is then inserted into the opening 1b of the translucent ceramics discharge vessel 1. Laser beams are then applied as is the case with the twelfth embodiment to form a seal.

The thirteenth embodiment produces effects similar to those of the twelfth embodiment.

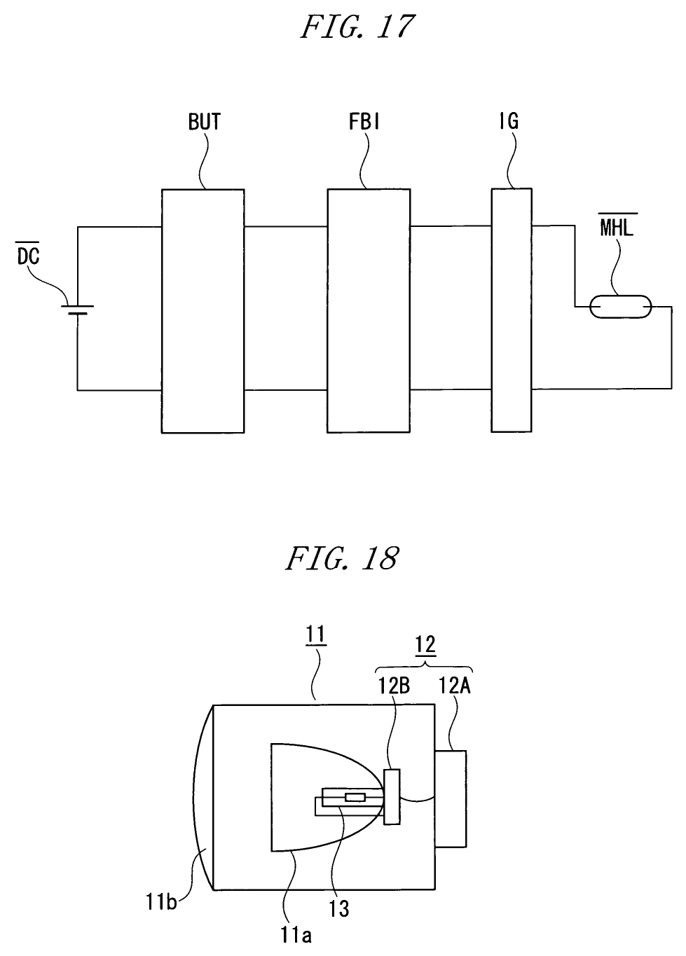

FIG. 17 is a block circuit diagram showing an embodiment of high-pressure discharge lamp operating apparatus of the present invention. In the present embodiment, a lighting circuit employs a low-frequency AC lighting circuit system. In the figure, reference characters DC, BUT, and FBI denotes a DC power source, a step-up chopper, and a full bridge type inverter, respectively. Reference characters IG and MHL denote an igniter and a metal halide lamp for an automotive headlamp, respectively.

The DC power source DC consists of, for example, an automotive battery.

The step-up chopper BUT has an input end connected to the DC power source DC.

The full bridge type inverter FBI has an input end connected to an output end of the step-up chopper BUT.

A low-frequency AC output from the full bridge type inverter FBI is input to the igniter IG, which then generates and applies a high-voltage starting pulse to a pair of electrodes of the metal halide lamp MHL for an automotive headlamp, described later at a start time.

The metal halide lamp MHL for an automotive headlamp is configured as shown in FIGS. 1 and 2. The metal halide lamp MHL is connected to between output ends of the full bridge type inverter FBI to accomplish low-frequency AC lighting.

FIG. 18 is a conceptual side view showing an automotive headlamp as an embodiment of the illuminating apparatus of the present invention. In this figure, reference numerals 11, 12, and 13 denote a headlamp main body, a high-pressure discharge lamp operating apparatus, and a metal halide lamp for an automotive headlamp.

The headlamp main body 11 is shaped like a container. The headlamp main body 11 comprises a reflector 11a provided inside, a lens 11a provided on its front surface, a lamp socket (not shown), and the like.

The high-pressure discharge operating apparatus 12 has a circuit configuration shown in FIG. 3 and comprises a main lighting circuit 12A and a starter 12B. The main lighting circuit 12A is composed mainly of the step-up chopper BUT and full bridge type inverter FBI, shown in FIG. 3. The starter 12B is also composed mainly of the igniter IG.

The metal halide lamp 13 for an automotive headlamp is installed in the lamp socket and lighted.

What is claimed is:

1. A high-pressure discharge lamp comprising:
translucent ceramics discharge vessel including an opening;
a current introducing conductor inserted into and sealed to the opening of the translucent ceramics discharge vessel;
electrodes connected to the current introducing conductor and sealed in the translucent ceramics discharge vessel;
a discharge medium sealed in the translucent ceramics discharge vessel,
wherein the sealing of the current introducing conductor is mainly provided by the fusion of ceramics in the opening of the translucent ceramics discharge vessel.

2. The high-pressure discharge lamp according to claim 1, wherein the current introducing conductor is airtightly fused to the translucent ceramics discharge vessel by melting the ceramics at least in the opening of the translucent ceramics discharge vessel.

3. The high-pressure discharge lamp according to claim 1 or 2, wherein the current introducing conductor comprises a cup made of a thin, halogen-resistant metal and which covers a niobium part that is opposite at least the opening of the translucent ceramics discharge vessel and a leading end of the niobium part which is located in the translucent ceramics discharge vessel.

4. The high-pressure discharge lamp according to claim 1 or 2, wherein the current introducing conductor comprises a niobium part that is opposite at least the opening of the translucent ceramics discharge vessel, and a sealing material comprising a niobium base material and a film made of a material of the same quality as that of the translucent ceramics discharge vessel, the film being attached to at least one surface of the niobium base material, the sealing material being placed outside an opening end of the translucent ceramics discharge vessel to form a seal between the opening of the translucent ceramics discharge vessel and the current introducing conductor.

5. A high-pressure discharge lamp comprising:
a translucent ceramics discharge vessel including an opening;
a current introducing conductor inserted into and sealed to the opening of the translucent ceramics discharge vessel;
electrodes connected to the current introducing conductor and sealed in the translucent ceramics discharge vessel; and
a discharge medium sealed in the translucent ceramics discharge vessel,
wherein the sealing of the current introducing conductor is carried out mostly by fusing a material of the same quality as that of a part of the current introducing conductor which is opposite the opening.

6. The high-pressure discharge lamp according to claim 5, wherein a part of the current introducing conductor which is opposite at least the opening of the translucent ceramics discharge vessel comprises cermet.

7. The high-pressure discharge lamp according to claim 6, wherein the current introducing conductor comprises a metal bar part located adjacent to a cermet part and withdrawn into at least a portion of the cermet part.

8. The high-pressure discharge lamp according to claim 6 or 7, wherein an unsealed part formed between the cermet part of the current introducing conductor and the opening of the translucent ceramics discharge vessel has an unsealed part average gap of 20 to 200 μm.

9. The high-pressure discharge lamp according to any one of claims 6 to 8, wherein a cermet part sealed to the translucent ceramics discharge vessel of the current introducing conductor contains at least a metal component such as niobium (Nb), molybdenum (Mo), or tungsten and a ceramic component such as alumina, YAG, or yttrium, and the content of the metal component is 5 to 60 mass %.

10. The high-pressure discharge lamp according to any one of claims 6 to 8 wherein a cermet part of the current introducing conductor which is sealed to the translucent ceramics discharge vessel contains at least a metal component such as niobium (Nb), molybdenum (Mo), or tungsten and a ceramic component such as alumina, YAG, or yttrium, and the content of the metal component is 50 to 80 mass %.

11. The high-pressure discharge lamp according to any one of claims 6 to 10, wherein the current introducing conductor comprises a front layer on an outer peripheral surface of the cermet part, the front layer mainly comprising a material of the same quality as that of the translucent ceramics discharge vessel, and the seal part between the opening of the translucent ceramics discharge vessel and the current introducing conductor is formed by converting at least the front layer and the opening of the translucent ceramics discharge vessel into a solid solution.

12. The high-pressure discharge lamp according to any one of claims 1 to 11, wherein the translucent ceramics discharge vessel comprises an opening having a tapered part with a diameter increasing toward the exterior, and
wherein the current introducing conductor comprises a tapered part inserted into the opening of the translucent ceramics discharge vessel, and at least a portion of the tapered part which is opposite the tapered part of the opening fits the opening.

13. The high-pressure discharge lamp according to any one of claims 1 to 12, wherein a part of the current introducing conductor which is opposite the inner surface at least of the opening of the translucent ceramics discharge vessel comprises a conductive substance bar, and a sealing material having a niobium layer covering a peripheral surface of the conductive substance bar and a layer of a material of the same quality as that of the translucent ceramics discharge vessel which layer covers the outer surface of the niobium layer, and in which the seal part between the opening of the translucent ceramics discharge vessel and the current introducing conductor is formed by the fusion at least of the sealing material.

14. The high-pressure discharge lamp according to any of claims 1 to 12, wherein a part of the current introducing conductor which is opposite the inner surface at least of the opening of the translucent ceramics discharge vessel comprises a conductive substance bar, and a sealing material including a layer of a material of the same quality as that of the translucent ceramics discharge vessel which layer is attached to a peripheral surface of the conductive substance bar, and a niobium layer formed on said layer, and wherein the seal part between the opening of the translucent ceramics discharge vessel and the current introducing conductor is formed by the fusion at least of the sealing material.

15. The high-pressure discharge lamp according to any one of claims 1 to 14, wherein the translucent ceramics discharge vessel comprises translucent polycrystalline alumina ceramics.

16. The high-pressure discharge lamp according to claim 15, wherein the translucent polycrystalline alumina ceramics have an average crystal grain size of at most 4 μm at least in the opening.

17. A high-pressure discharge lamp operating apparatus comprising:
the high-pressure discharge lamp according to any one of claims 1 to 16; and
a lighting circuit that lights the high-pressure discharge lamp.

18. An illuminating apparatus comprising:
an illuminating apparatus main body;
the high-pressure discharge lamp according to any one of claims 1 to 16 disposed in the illuminating apparatus main body; and
a lighting circuit that lights the high-pressure discharge lamp.
